(19) United States
(12) Patent Application Publication
(10) Pub. No.: US 2019/0350181 A1
(43) Pub. Date: Nov. 21, 2019

(54) FISHING ROD TIP

(71) Applicant: Thomas Bricko, Farmington, MN (US)

(72) Inventor: Thomas Bricko, Farmington, MN (US)

(21) Appl. No.: 16/265,539

(22) Filed: Feb. 1, 2019

Related U.S. Application Data
(60) Provisional application No. 62/625,029, filed on Feb. 1, 2018.

(51) Int. Cl. A01K 87/04; B21D 53/16

(52) U.S. Cl. CPC A01K 87/04; B21D 53/16

(57) ABSTRACT

A fishing rod tip comprised of a tapered wire in a single formed assembly. The wire of the rod tip comprised of a Nickel Titanium alloy and specifically adapted to maintain its shape in extremely cold temperatures.

### CROSS REFERENCE TO RELATED APPLICATIONS

This application claims priority to U.S. Provisional Patent Application No. 62/625,029 filed 1 Feb. 2018 to the above-named inventor, and is herein incorporated by reference in its entirety.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The present invention relates to an improved tip configured for placement on a fishing rod/pole end.

### SUMMARY OF THE INVENTION

The device of the present disclosure relates to an improved fishing rod tip that is configured for placement on an existing fishing rod or fishing pole end that may be provided as an addition to an existing rod/pole or integrated directly into a fishing rod/pole. Within the present disclosure, the terms fishing rod and fishing pole and fishing rod/pole and rod/pole and rod or pole are used synonymously, wherein a fishing rod and fishing pole and fishing rod/pole and rod/pole and rod or pole refers to long tapered rod constructed of natural elements, such as, but not limited to, cane, reed, or bamboo, or composite materials, such as, but not limited to, graphite, fiberglass, boron, Kevlar, or combinations of these materials, to which a fishing line is attached, typically on a reel.

The rod tip of the present disclosure is provided in a specific shape and comprised of a specific material composition configured for placement on an end of the rod/pole and configured to deflect in a specific arc and in tandem with the rod/pole the device is placed upon and further optimized for performance in use at extremely cold temperatures.

The device of the present disclosure is comprised of a single wire specifically shaped and configured to enable the features of the device. Accordingly, the wire is tapered in profile from an attached end to a free end with a length of the wire forming a body portion. The free end shaped to form a loop. The loop positioned at angle outward and opposed from the attached end, wherein the angle between the wire body portion and the loop is generally obtuse. Accordingly, the angle of the loop relative to the body portion is between 100 and 120 degrees, with 111 degrees being preferred. The loop is generally formed from a shaping of the wire, wherein the loop is secured through a swage between a loop end and the body portion in an adjacent assembly. Accordingly, the loop is configured so as to be integrated with the body portion to form an eyelet having a shape configured to receive a fishing line.

The tapered body portion of the wire is configured to provide a parabolic/load deflection curve adapted to mimic the curve of the pole/rod the device is placed upon or integrated within. Accordingly, the attached end is provided in a wire diameter that is greater than the diameter of the wire of the device at the free end.

The wire is preferably selected from alloy of Nickel and Titanium and known as Nitinol within the art. This Nitinol alloy may include the addition of alternate and complimentary elements to increase resistance to cold temperatures and increased tensile strength, such as, but not including Cobalt.

The device of the present disclosure is generally adapted in multiple configurations wherein the device can be affixed at the end of an existing fishing rod through use of a material adapted to fasten the device to the rod or integrated directly into a manufactured rod at an end portion of the rod. The material adapted to fasten the device to the pole/rod is selected to provide a secure connection and may include, but not be limited to, serving thread, epoxy, adhesive, heat shrink tubing, and other similar materials.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 is an isometric view of a rod tip device, according to the present disclosure;

FIG. 2 is a side view of the rod tip device, according to the present disclosure;

FIG. 3 is an end view of the rod tip device, according to the present disclosure; and

FIG. 4 is a side view of the deflection/load curve of the rod tip, according to the present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

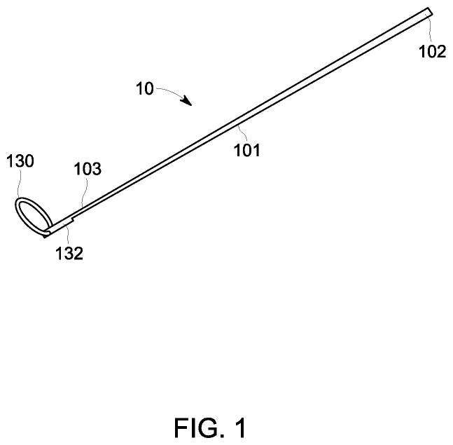

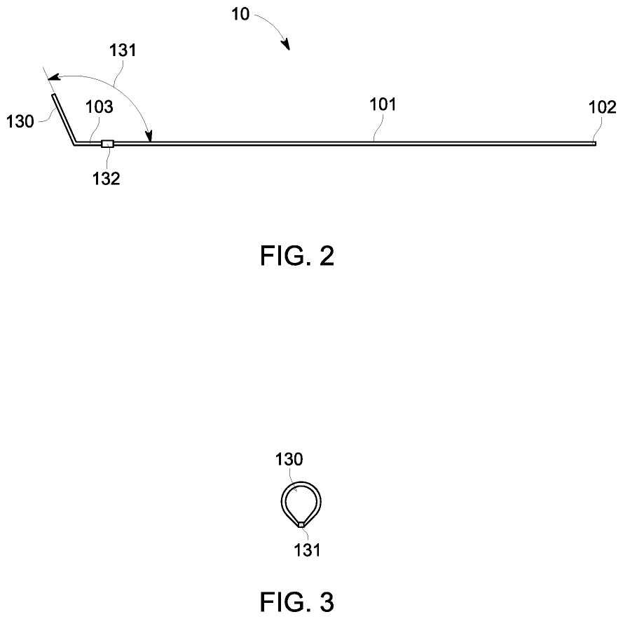

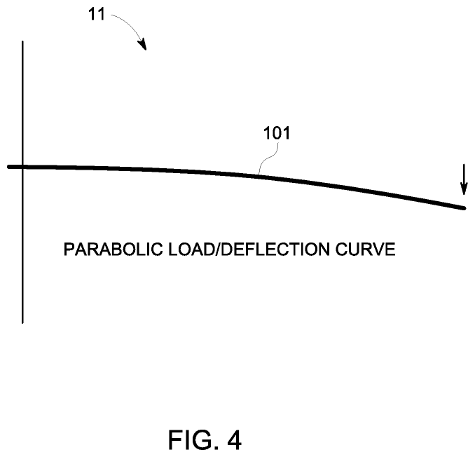

Referring now to FIGS. 1-4, an isometric view of a fishing rod tip of the present disclosure is shown and generally referred to as device 10. The device 10 is generally configured as an improved fishing rod tip or end that is configured for placement on an existing rod/pole or integrated directly into the end of a fishing rod or fishing pole. The rod tip 10 of the present disclosure is provided in a specific shape and comprised of a specific material adapted to deflect in an arc specifically selected to move in tandem with the rod/pole the device 10 is affixed to or integrated with.

The device 10 is comprised of and constructed from a single wire specifically shaped and adapted to enable the features of the device 10. Accordingly, the wire is tapered in profile from an attached end 102 to a free end 103 with a length of the wire of the device 10 forming a body portion 101. The free end 103 shaped to form a loop 130. The loop 130 positioned at angle 131 outward and opposed from the attached end 102, wherein the angle 131 between the wire body portion 101 and the loop 130 is obtuse. Accordingly, the angle 131 of the loop 130 relative to the body portion 101 is between 100 degrees and 120 degrees, with 111 degrees being the preferred angle 131 position. The loop 130 is generally formed from a shaping of the wire of the device 10, wherein the loop 130 is secured through a swage 132 between the free end 103 and the body portion 101 in an adjacent assembly. The loop 130 is configured as an integrated eyelet having a shape to receive a fishing line.

The tapered body portion 101 of the wire is adapted to provide a parabolic/load deflection curve 11 adapted to mimic the curve of the rod the device 10 is placed upon or integrated within. Accordingly, the attached end 102 is generally provided in a diameter that is greater than the diameter of the wire of the device 10 at the free end 103.

The wire of the device 10 is preferably selected from alloy of Nickel and Titanium and known as Nitinol within the art. This alloy can be modified in several alloy types and configurations to ensure performance of the device in cold temperatures. Alternately, this Nitinol alloy may include the addition of alternate and complimentary elements to increase resistance to cold temperatures and increased tensile strength, such as Cobalt. Preferably, this Cobalt is added to the Nitinol alloy through a doping process to impart the desired characteristics for the material and construction of the device 10. Accordingly, the alloy of the device 10 of present disclosure is specifically formulated to maintain flexibility in extremely cold temperatures, be repairable should a kink occur, and be durable for outdoor use.

The device 10 of the present disclosure is generally adapted in multiple configurations wherein the device 10 can be affixed at the end of an existing fishing rod through use of a material adapted to fasten the device to the rod or integrated directly into a manufactured rod. The material adapted to fasten the device 10 to the rod including, but not limited to, serving thread, epoxy, adhesive, heat shrink tubing, and other similar materials.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) but that the invention will include all embodiments falling with the scope of the specification.

What is claimed is:

1. A fishing rod tip, the fishing rod tip comprising:
an attached end;
a free end opposite the attached end;
a body portion defining a length and extending between the free end and the attached end, the body portion having a diameter, the diameter larger at the attached end when compared to the free end to form a tapered shape; and
a loop, the loop at the free end and positioned at an angle outward and opposite the attached end, wherein the angle is obtuse when measured between the body portion and the free end.

2. The fishing rod tip as in claim 1, wherein the tip is formed from a single metal wire consisting of an alloy of Nickel and Titanium.

3. The fishing rod tip as in claim 1, wherein the angle of the loop relative to the attached end is between a range of 100 degrees and 120 degrees.

4. The fishing rod tip as in claim 1, wherein the angle of the loop relative to the attached end is 111 degrees.

5. The fishing rod tip as in claim 3, wherein the loop is formed from the free end and swaged to the body portion.

6. The fishing rod tip as in claim 1, wherein the tip is capable of maintaining a shape and spring force at a temperature below freezing.

7. The fishing rod tip as in claim 2, wherein the tip is fastened to an existing fishing rod.

8. The fishing rod tip as in claim 2, wherein the tip is integrated into an end portion of a fishing rod.

9. A fishing rod tip, the fishing rod tip consisting of a single wire, the rod tip comprising:
an attached end;
a free end opposite the attached end;
a body portion defining a length and extending between the free end and the attached end; and
a loop, the loop at the free end and positioned at an angle outward and opposite the attached end, wherein the angle is obtuse when measured between the body portion and the free end.

10. The fishing rod tip as in claim 9, wherein the body portion has a diameter, the diameter larger at the attached end when compared to the free end to form a tapered shape.

11. The fishing rod tip as in claim 10, wherein the rod tip is formed from a metal consisting of an alloy of Nickel and Titanium.

12. The fishing rod tip as in claim 10, wherein the angle of the loop relative to the attached end is between a range of 100 degrees and 120 degrees.

13. The fishing rod tip as in claim 10, wherein the angle of the loop relative to the attached end is 111 degrees.

14. The fishing rod tip as in claim 10, wherein the loop is formed from the free end and swaged to the body portion.

15. The fishing rod tip as in claim 10, wherein the tip is capable of maintaining a shape and a spring force at a temperature below freezing.

16. The fishing rod tip as in claim 10, wherein the tip is fastened to an existing fishing rod.

17. The fishing rod tip as in claim 10, wherein the tip is integrated into an end portion of a fishing rod.

18. The fishing rod tip as in claim 11, wherein the rod tip is formed from a metal alloy including Cobalt.
